(19) United States
(12) Patent Application Publication
(10) Pub. No.: US 2001/0026320 A1
(43) Pub. Date: Oct. 4, 2001

(54) Photographing device capable of adjusting image sizes and controlling method thereof

(75) Inventor: In-Seok Seo, Suwon-city (KR)

Correspondence Address: Finnegan, Henderson, Farabow,, Garrett & Dunner, L.L.P., 1300 I Street, N.W., Washington, DC, 20005-3315, US

(73) Assignee: SAMSUNG TECHWIN CO., LTD.

(21) Appl. No.: 09/816,116

(22) Filed: Mar. 26, 2001

(30) Foreign Application Priority Data
Mar. 31, 2000 (KR) 2000-16997

(51) Int. Cl. H04N 5/76

(52) U.S. Cl. 348/222; 348/231; 348/581

(57) ABSTRACT

Disclosed is a photographing method capable of adjusting image sizes, which comprises (a) restoring image signals captured by a first mode size and stored in a first memory and storing the restored image signals in a second memory; (b) determining whether to select a modification operation for modifying the image signals captured by the first mode size into those of the second mode size; (c) deleting the image signals stored in the first memory when the modification operation is selected; (d) sampling the image signals restored in the second memory; (e) compressing the sampled image signals according to a compression ratio corresponding to the second mode; and (f) storing the compressed image signals in the first memory.

### BACKGROUND OF THE INVENTION

(a) Field of the Invention

The present invention relates to a photographing device capable of adjusting image sizes and controlling method thereof. More specifically, the present invention relates to a photographing device and method capable of adjusting sizes of captured images by an image camera for electrically capturing images of subjects.

(b) Description of the Related Art

In general, a photographing device such as an image camera electrically records two-dimensional information on photographed subjects. The image camera, such as a digital still camera or a charge coupled device (CCD) camera, converts optical images of the subjects into electrical images, stores the same in a memory, and when necessary, the image camera reads the stored images and prints the same or transmits the same to a computer.

When using the image camera (particularly the digital still camera), sizes of the image data files captured and stored according to photographing modes are varied. That is, in the case of a large size mode for printing the captured images, the number of pixels per frame is increased and a compression rate is decreased to obtain better image quality. Since the image data file becomes greater in size in this large size mode as the number of the pixels is increased, the number of the frames to be recorded in the memory is reduced.

Differing from this, in the case of a small size mode for photographing many cuts of images, the number of the pixels that configures a screen is reduced and the compression rate is increased. Therefore, since the image data file becomes smaller in size, the number of the cuts recorded in the memory is greatly increased compared to that of the large size mode.

For example, in the case an image data captured using a CCD that has pixels of 1280×1024 is stored in a 4 MB memory card, when the photographing mode is a large size mode, the screen size of the captured image data is set to be 1280×1024 identical with that of the CCD, the image data are compressed by the ratio of 4 to 1, and the compressed data are stored in the memory card. In this case, about five cuts of images are recorded in the memory card.

However, in the case of the small size mode, the screen size of the captured image data is set to be 640×480, the image data are compressed by the ratio of 8 to 1, and the compressed data are stored in the memory card, and hence, about 43 cuts of the images can be recorded in the memory card.

When storing the image data captured according to the above-noted modes, a user cannot photograph more than five cuts of the images via the large size mode.

Therefore, the user can miss exact image capturing moments.

### SUMMARY OF THE INVENTION

It is an object of the present invention to provide a photographing device for modifying captured image data stored in a memory by a large size mode into image data of a small size mode and storing the modified data in the memory.

In one aspect of the present invention, a photographing device capable of adjusting image sizes comprises: an image capturing unit for capturing an image of a subject and generating corresponding image signals; a first memory for compressing the image signals output by the image capturing unit per frame and storing the compressed image signals; a second memory for restoring the compressed image signals and storing the restored image signals; a selection unit for selecting photographing modes that stores one frame image signals as the size of a first mode or a second mode; and a microprocessor for restoring the corresponding image signals stored in the first memory, storing the restored image signals in the second memory, deleting the image signals of the first memory, sampling the restored image signals of the second memory, compressing the sampled image signals according to a compression ratio corresponding to the second mode, and storing the compressed image signals in the first memory when a user wishes to modify the image signals captured by the first mode size into image signals of the second mode size, the size of the first mode being greater than that of the second mode.

The image capturing unit comprises: an image capturing lens for forming an image of the subject; a charge coupled device (CCD) for capturing the image of the subject and outputting corresponding analog signals; an analog signal processor for processing the analog signals output by the CCD and removing noises; a signal converter for converting the analog signals into digital signals; and a digital signal processor (DSP) for processing the digital signals and generating corresponding image signals.

In another aspect of the present invention, a photographing method capable of adjusting image sizes comprises: restoring image signals captured by a first mode size and stored in a first memory and storing the restored image signals in a second memory; determining whether to select a modification operation for modifying the image signals captured by the first mode size into those of the second mode size; deleting the image signals stored in the first memory when the modification operation is selected; sampling the image signals restored in the second memory; compressing the sampled image signals according to a compression ratio corresponding to the second mode; and storing the compressed image signals in the first memory.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows a photographing device capable of adjusting an image size according to a preferred embodiment of the present invention; and

FIG. 2 shows a flow chart of a photographing method capable of adjusting an image size according to the preferred embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

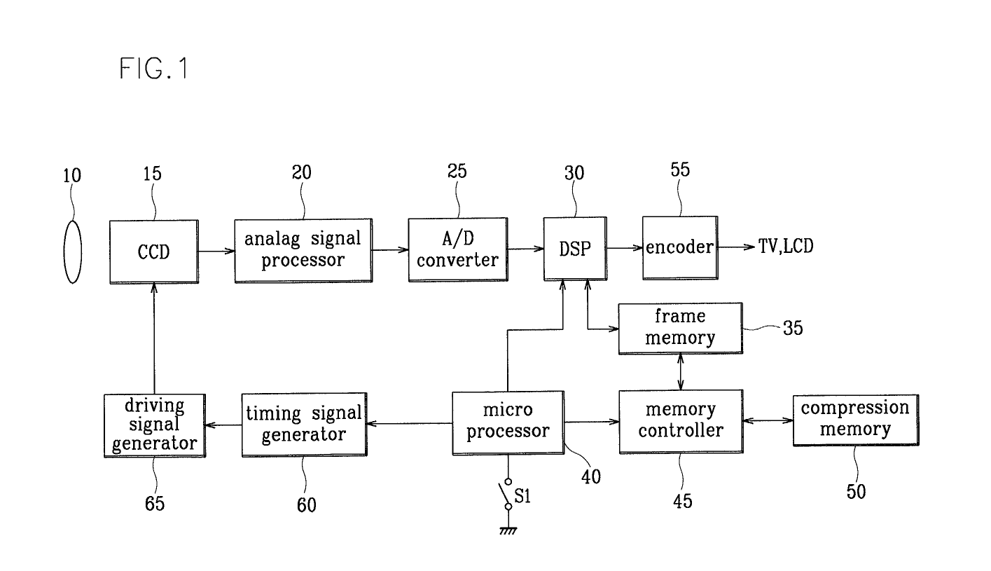

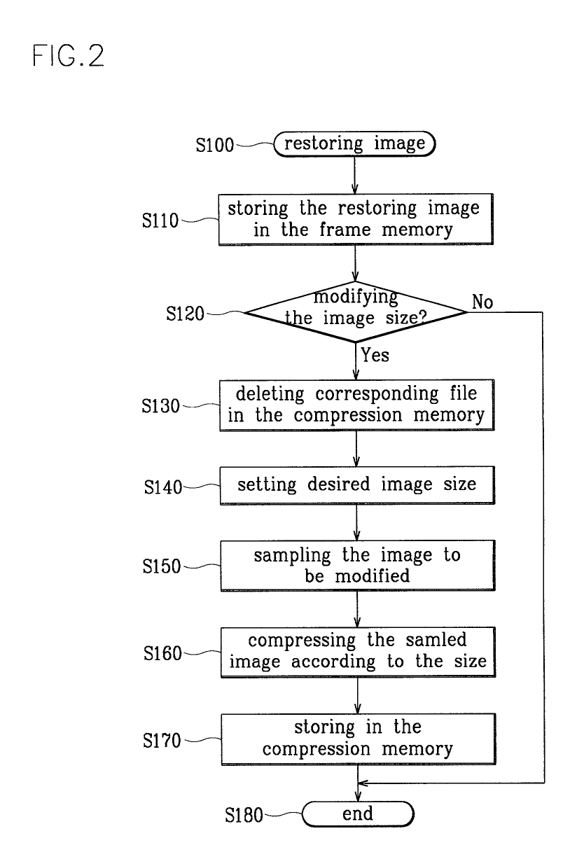

FIG. 1 shows a photographing device capable of adjusting an image size according to a preferred embodiment of the present invention, and FIG. 2 shows a flow chart of a photographing method capable of adjusting an image size according to the preferred embodiment of the present invention.

As shown in FIG. 1, the photographing device capable of adjusting an image size comprises an image capturing lens 10, a CCD 15, an analog signal processor 20, an analog/digital (A/D) converter 25, a digital signal processor (DSP) 30, a frame memory 35, a microprocessor 40, a memory controller 45, a compression memory 50, an encoder 55, a timing signal generator 60 and a driving signal generator 65.

The image capturing lens 10 forms an image of a subject to be captured on an incidence surface of the CCD 15. The CCD 15 converts the formed image of the subject into corresponding electrical analog signals and outputs the same. The CCD 15 according to the present invention has the pixel number of 1280×1024, but the pixel number is not restricted to this.

The analog signal processor 20 comprises a correlated double sampling (CDS) unit for performing a correlated double sampling process on the analog signals output by the CCD 15, and an analog gain control (AGC) unit for adjusting gains of the analog signals.

The A/D converter 25 converts the analog signals output by the analog signal processor 20 into digital signals.

The DSP 30 processes the digital signals to generate image signals.

The frame memory 35 stores image signals of a first frame to be displayed, and the compression memory 50 compresses the captured image signals per frame and stores the same.

The microprocessor 40 controls generation, storage, display, compression and restoration of the image signals, and the memory controller 45 performs input/output operations of the image signals to the frame memory 35 and the compression memory 50 according to control of the microprocessor 40.

The encoder 55 converts the captured image signals to displayable signals and outputs the same to a liquid crystal display (LCD) or a television set. The timing signal generator 60 generates timing signals according to the control of the microprocessor 40, and the driving signal generator 65 generates driving signals for driving photographing operations of the CCD 15 according to the timing signals.

The photographing device capable of adjusting the image sizes further comprises a mode selection switch S1 for selecting a large size mode that stores the captured image data (which will be referred to as image signals hereinafter) into a first size that is 1280×1024 and identical with the screen size of the CCD 15, or a small size mode that stores the image signals into a second size that is 640×480. The mode selection switch S1 is connected to the microprocessor 40.

The first and second sizes can be varied according to the screen sizes of the CCD.

An operation of the photographing device capable of adjusting the image sizes will now be described.

In the preferred embodiment of the present invention, the size of the image captured by the digital still camera is adjusted, but the present invention is not restricted to this.

When the power is supplied to the photographing device, that is, a digital still camera, the microprocessor 40 drives the timing signal generator 60, and the timing signal generator 60 generates timing signals according to the control of the microprocessor 40. The driving signal generator 65 generates driving signals for driving the CCD 15 according to the timing signals and outputs the driving signals to the CCD 15.

Rays corresponding to the subject are passed through the image capturing lens 10 and formed on the incidence surface of the CCD 15, and the CCD 15 captures the formed image of the substrate according to the driving signal supplied by the driving signal generator 65 and outputs corresponding analog signals.

The analog signals are input to the analog signal processor 20, and the analog signal processor 20 performs a correlated double sampling process on the input analog signals to remove noises, adjusts signal gains and outputs the same. As described above, the analog signals processed by the analog signal processor 20 are converted into digital signals by the A/D converter 25 and input to the DSP 30.

The DSP 30 processes the digital signals according to a general signal processing method and generates corresponding image signals. The image signals are stored in the frame memory 35 according to the control of the microprocessor 40 to form one frame corresponding to one screen. The image signals include color and luminance signals.

When one frame image signals are generated, the microprocessor 40 compresses the one frame image signals stored in the frame memory 35 according to the established photographing mode and stores the compressed image signals in the compression memory 50.

That is, when the large size mode is selected via the mode selection switch S1, the microprocessor 40 sets the screen size of the captured one frame image signals as 1280×1024 that is identical with that of the CCD 15, compresses the image signals by the ratio of 4:1 and stores the compressed image signals in the compression memory 50.

When the small size mode is selected, the microprocessor 40 sets the screen size as 640×480, compresses the image signals by the ratio of 8:1 and stores the compressed image signals in the compression memory 50.

In this case, the memory controller 45 stores the compressed image signals in the compression memory according to the control of the microprocessor 40. By the above-described photographing operation, image signals of plural frames are compressed and stored in the compression memory 50 per frame.

When a user wishes to watch the stored images via an LCD installed in the digital still camera or an external television, the microprocessor 40 restores the image signals stored in the compression memory 50 and outputs the restored image signals to the frame memory 35. The output image signals are converted into displayable signals via the encoder 55, and displayed to a television or other displays (not illustrated).

As shown in FIG. 2, in the case the user manipulates the mode selection switch S1 and select the small size mode so as to capture image cuts more than those of the large size mode while the image signals are restored and the image signals captured by the large size mode and displayed are not removed, the microprocessor 40 starts an operation to modify the image signals captured by the large size mode and stored into the image signals of the small size mode in steps S100 to S120.

First, the microprocessor 40 deletes the file of the compression memory 50 corresponding to the one frame image signal file restored in the frame memory 35 in step S130, and samples the image signals restored in the frame memory 35 by an identical ratio with respect to the vertical and horizontal pixels in step S140. That is, the microprocessor 40 selects two pixels from the pixels that configure the image signals or one pixel from the plural pixels and samples the image signals.

The microprocessor 40 compresses the sampled one frame image signals by the ratio of 8:1 according to the small size mode and stores the compressed image signals in the compression memory 50 in steps S150 and S160, and therefore, the one frame image signals captured by the large size mode are modified into the image signals of the small size mode and stored in the compression memory 50 in step S170.

According to the above-described operation, storage capacity of the compression memory 50 is increased, and the user can photograph more cuts than those of the large size mode and store them in the compression memory 50.

Hence, the user can easily photograph more picture cuts than established number of cuts without deleting previously captured image data in the large size mode.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A photographing device capable of adjusting image sizes, comprising:
an image capturing unit for capturing an image of a subject and generating corresponding image signals;
a first memory for compressing the image signals output by the image capturing unit per frame and storing the compressed image signals;
a second memory for restoring the compressed image signals and storing the restored image signals;
a selection unit for selecting photographing modes that stores one frame image signals as the size of a first mode or a second mode; and
a microprocessor for restoring the corresponding image signals stored in the first memory, storing the restored image signals in the second memory, deleting the image signals of the first memory, sampling the restored image signals of the second memory, compressing the sampled image signals according to a compression ratio corresponding to the second mode, and storing the compressed image signals in the first memory when a user wishes to modify the image signals captured by the first mode size into image signals of the second mode size, the size of the first mode being greater than that of the second mode.

2. The photographing device of claim 1, wherein the image capturing unit comprises:
a image capturing lens for forming an image of the subject;
a charge coupled device (CCD) for capturing the image of the subject and outputting corresponding analog signals;
an analog signal processor for processing the analog signals output by the CCD and removing noises;
a signal converter for converting the analog signals into digital signals; and
a digital signal processor (DSP) for processing the digital signals and generating corresponding image signals.

3. The photographing device of claim 1, wherein the image capturing device further comprises a memory controller for inputting and outputting the image signals to the first and second memories according to control of the microprocessor.

4. A photographing method capable of adjusting image sizes, comprising:
restoring image signals captured by a first mode size and stored in a first memory and storing the restored image signals in a second memory;
determining whether to select a modification operation for modifying the image signals captured by the first mode size into those of the second mode size;
deleting the image signals stored in the first memory when the modification operation is selected;
sampling the image signals restored in the second memory;
compressing the sampled image signals according to a compression ratio corresponding to the second mode; and
storing the compressed image signals in the first memory.
